(19) United States
(12) Patent Application Publication
(10) Pub. No.: US 2024/0178682 A1
(43) Pub. Date: May 30, 2024

(54) WIRELESS CHARGER AND DESK

(71) Applicant: SHENZHEN BESTQI INNOVATION TECHNOLOGY CO., LTD, Shenzhen (CN)

(72) Inventor: Jinguan Wu, Shenzhen (CN)

(21) Appl. No.: 18/095,465

(22) Filed: Jan. 10, 2023

(30) Foreign Application Priority Data
Nov. 25, 2022 (CN) 202211497179.7

(51) Int. Cl. H02J 7/00

(52) U.S. Cl. CPC H02J 7/0044; H02J 2207/10

(57) ABSTRACT

A wireless charger and a desk are disclosed. The wireless charger includes a base, a charging stand, a driving assembly and a controller. The charging stand is connected to the base and is rotatable around a horizontal axis relative to the base, and the charging stand is configured for placing an electronic device and wirelessly charging the electronic device. The controller is electrically connected with the driving assembly and configured for controlling the driving assembly to drive the charging stand to rotate from an initial posture to an upright posture in response to placing the electronic device on the charging stand. When the charging stand is in the upright posture, an included angle between the electronic device placed on the charging stand and a horizontal plane is greater than 0 degree and less than or equal to 90 degrees.

### CROSS-REFERENCE TO RELATED APPLICATION

This application is based on and claims the benefit of priority from Chinese Patent Application No. 202211497179.7, filed on Nov. 25, 2022, the entirety of which is incorporated by reference herein.

### TECHNICAL FIELD

The present disclosure relates to the technical field of electronic devices, and particularly to a wireless charger and a desk.

### BACKGROUND

With the development of technology, wireless charging technology is more and more widely applied in daily charging of electronic devices. At present, there is a wireless charger on the market, which comprises a base and a charging stand, wherein the charging stand is capable of being upright relative to the base during charging, thus being convenient for a user to use an electronic device during charging, and the charging stand is capable of being reset when the electronic device is not charging, thus reducing the volume of the wireless charger. In the related art, the charging stand needs to be manually driven by the user to stand upright, which is inconvenient to use.

### SUMMARY

The present disclosure aims at solving at least one of the technical problems in the existing technology. Therefore, the present disclosure provides a wireless charger, which can simplify the charging operation of a user.

The present disclosure further provides a desk using the wireless charger.

The wireless charger according to embodiments of the present disclosure, which is configured for wirelessly charging an electronic device, comprises:
a base;
a charging stand connected to the base and rotatable around a horizontal axis relative to the base, wherein the charging stand is configured for placing the electronic device and wirelessly charging the electronic device;
a driving assembly; and
a controller electrically connected with the driving assembly and configured for controlling the driving assembly to drive the charging stand to rotate from an initial posture to an upright posture in response to placing the electronic device on the charging stand, wherein when the charging stand is in the upright posture, an included angle between the electronic device placed on the charging stand and a horizontal plane is greater than 0 degree and less than or equal to 90 degrees.

The wireless charger according to the embodiments of the present disclosure at least has the following beneficial effects.

The controller is electrically connected with the driving assembly, and the controller can automatically control the driving assembly to drive the charging seat to rotate from the initial posture to the upright posture in response to placing the electronic device on the charging seat. In this process, the user only needs to place the electronic device on the charging seat, without manually driving the charging seat to stand upright, or controlling the driving assembly to drive the charging seat to stand upright through a physical key or a virtual key, so that the operation is more convenient.

In some other embodiments of the present disclosure, the wireless charger further comprises a rotating seat, the rotating seat is connected to the base and is rotatable around a vertical axis relative to the base, and the charging stand is connected to the rotating seat and is rotatable around the horizontal axis relative to the rotating seat;
wherein the controller is configured for controlling the driving assembly to drive the charging stand to rotate from the initial posture to the upright posture and controlling the driving assembly to drive the rotating seat to rotate from an initial position to a set position or to rotate by a set angle in response to placing the electronic device on the charging stand.

In some other embodiments of the present disclosure, a top portion of the rotating seat defines a recess, and the wireless charger comprises at least one of the following solutions:
when the charging stand is in the initial posture, the charging stand is at least partially located in the recess; and
when the charging stand is in the upright posture, the charging stand and a wall of the recess define an accommodating space for accommodating a bottom end of the electronic device.

In some other embodiments of the present disclosure, the charging stand comprises a charging housing and a connecting portion connected to the charging housing, the connecting portion is provided with an arc surface and a plurality of first driving teeth distributed along a circumferential direction of the arc surface, the driving assembly comprises a first power element and a first gear connected to a driving end of the first power element, and the first gear is engaged with the first driving teeth.

In some other embodiments of the present disclosure, a bottom portion of the rotating seat and the base define a first mounting cavity, the rotating seat is provided with a guide portion located in the first mounting cavity, the guide portion defines a guide cavity, the connecting portion is slidably arranged in the guide cavity, and the wireless charger comprises at least one of the following solutions:
a wall of the guide cavity is provided with a first notch for the first gear to be engaged with the first driving teeth; and
the connecting portion further defines a trunking communicated with an inner cavity of the charging housing, the charging stand further comprises a charging coil arranged in the inner cavity and a wire electrically connected with the charging coil, the wire is arranged in the trunking, and the wall of the guide cavity is provided with a second notch for the wire to pass through.

In some other embodiments of the present disclosure, the rotating seat is provided with a plurality of second driving teeth distributed along a circumferential direction, the driving assembly comprises a second power element and a second gear connected to a driving end of the second power element, and the second gear is engaged with the second driving teeth.

In some other embodiments of the present disclosure, the base comprises a bottom plate, and an inner side plate and an outer side plate which are connected to the bottom plate, the outer side plate is located outside the inner side plate, the inner side plate and the bottom plate define a first mounting cavity, the inner side plate, the outer side plate and the bottom plate define a second mounting cavity, and the wireless charger comprises at least one of the following solutions:
the driving assembly comprises a first power element for driving the charging stand to rotate, and the first power element is arranged in the first mounting cavity;
the driving assembly comprises a second power element for driving the rotating seat to rotate, and the second power element is arranged in the second mounting cavity; and
the wireless charger further comprises an annular bearing, the annular bearing is arranged in the second mounting cavity, and the rotating seat is rotatably connected with the base through the annular bearing.

In some other embodiments of the present disclosure, the charging stand comprises a charging housing and a charging coil, and the controller is configured for controlling the driving assembly to drive the charging stand to rotate from the initial posture to the upright posture and controlling the driving assembly to drive the rotating seat to rotate from the initial position to the set position in response to placing the electronic device on the charging stand to charge the electronic device through the charging coil;
or, the charging stand comprises a sensor, the sensor is capable of being triggered by the electronic device placed on the charging stand, and the controller is configured for controlling the driving assembly to drive the charging stand to rotate from the initial posture to the upright posture and controlling the driving assembly to drive the rotating seat to rotate from the initial position to the set position in response to triggering of the sensor.

In some other embodiments of the present disclosure, the controller is configured for controlling the driving assembly to drive the charging stand to rotate from the upright posture to the initial posture and controlling the driving assembly to drive the rotating seat to rotate from the set position to the initial position in response to separation of the electronic device from the charging stand.

In some other embodiments of the present disclosure, a top portion of the base defines a recess, and the wireless charger comprises at least one of the following solutions: when the charging stand is in the initial posture, the charging stand is at least partially located in the recess; and when the charging stand is in the upright posture, the charging stand and a wall of the recess define an accommodating space for accommodating a bottom end of the electronic device.

In some other embodiments of the present disclosure, the charging stand comprises a charging housing and a connecting portion connected to the charging housing, the connecting portion is provided with an arc surface and a plurality of first driving teeth distributed along a circumferential direction of the arc surface, the driving assembly comprises a first power element and a first gear connected to a driving end of the first power element, and the first gear is engaged with the first driving teeth.

In some other embodiments of the present disclosure, the base defines a first mounting cavity, the base is provided with a guide portion located in the first mounting cavity, the guide portion defines a guide cavity, the connecting portion is slidably arranged in the guide cavity, and the wireless charger comprises at least one of the following solutions:
a wall of the guide cavity is provided with a first notch for the first gear to be engaged with the first driving teeth;
the connecting portion further defines a trunking communicated with an inner cavity of the charging housing, the charging stand further comprises a charging coil arranged in the inner cavity and a wire electrically connected with the charging coil, the wire is arranged in the trunking, and the wall of the guide cavity is provided with a second notch for the wire to pass through; and
the first power element is arranged in the first mounting cavity.

In some other embodiments of the present disclosure, the charging stand comprises a charging housing and a charging coil, and the controller is configured for controlling the driving assembly to drive the charging stand to rotate from the initial posture to the upright posture in response to placing the electronic device on the charging stand to charge the electronic device through the charging coil;
or, the charging stand comprises a sensor, the sensor is capable of being triggered by the electronic device placed on the charging stand, and the controller is configured for controlling the driving assembly to drive the charging stand to rotate from the initial posture to the upright posture in response to triggering of the sensor.

In some other embodiments of the present disclosure, the controller is configured for controlling the driving assembly to drive the charging stand to rotate from the upright posture to the initial posture in response to separation of the electronic device from the charging stand.

The desk according to embodiments of the present disclosure comprises:
a desk plate; and
the wireless charger, wherein the wireless charger is connected to the desk plate through the base.

In some other embodiments of the present disclosure, the desk plate is provided with a mounting hole for mounting the wireless charger, the mounting hole extends at least across an upper surface of the desk plate, and when the charging stand is in the initial posture, an upper surface of the charging stand is not higher than the upper surface of the desk plate.

Additional aspects and advantages of the present disclosure will be given in part in the following description, and will become apparent in part from the following description, or will be learned through the practice of the present disclosure.

### BRIEF DESCRIPTION OF THE DRAWINGS

The present disclosure will be further explained with reference to the accompanying drawings and embodiments hereinafter, wherein:

FIG. 1 is a three-dimensional schematic diagram of a charging stand of a wireless charger in an upright posture in the embodiments of the present disclosure;

FIG. 2 is a three-dimensional schematic diagram of the wireless charger in FIG. 1 in another direction;

FIG. 3 is a three-dimensional schematic diagram of the wireless charger in FIG. 1 in an initial posture;

FIG. 4 is a sectional view of the wireless charger in FIG. 3;

FIG. 5 is a sectional view of the wireless charger in FIG. 1, with an electronic device shown in the figure;

FIG. 6 is a sectional view of the wireless charger in FIG. 1, with the electronic device hidden in the figure;

FIG. 7 is a three-dimensional schematic diagram of the wireless charger in FIG. 1 in one direction;

FIG. 8 is a three-dimensional schematic diagram of the charging stand in FIG. 1 in another direction;

FIG. 9 is a three-dimensional schematic diagram of a rotating seat in FIG. 1 in one direction;

FIG. 10 is a sectional view of the rotating seat in FIG. 1;

FIG. 11 is a three-dimensional schematic diagram of a base in FIG. 1;

FIG. 12 is a sectional view of the base in FIG. 1;

FIG. 13 is a three-dimensional schematic diagram of a desk in the embodiments of the present disclosure, with the charging stand in the upright posture in the figure;

FIG. 14 is a three-dimensional schematic diagram of a desk in the embodiments of the present disclosure, with the charging stand in the initial posture in the figure; and

FIG. 15 is a sectional view of the desk in the embodiments of the present disclosure.

### REFERENCE NUMERALS

10 refers to wireless charger;
100 refers to base, 110 refers to first mounting cavity, 120 refers to second mounting cavity, 130 refers to bottom plate. 140 refers to inner side plate, and 150 refers to outer side plate;
200 refers to charging stand, 210 refers to charging housing. 211 refers to inner cavity 211, 220 refers to connecting portion, 221 refers to arc surface. 222 refers to first driving teeth, 223 refers to trunking. 230 refers to charging coil, and 240 refers to wire;
300 refers to driving assembly. 310 refers to first power element. 320 refers to second power element. 330 refers to first gear, and 340 refers to second gear;
400 refers to rotating seat. 410 refers to recess. 411 refers to accommodating space, 420 refers to guide portion, 421 refers to guide cavity, 422 refers to first notch. 423 refers to second notch, and 430 refers to second driving teeth;
500 refers to annular bearing;
600 refers to circuit board;
20 refers to electronic device; and
30 refers to desk plate.

### DETAILED DESCRIPTION

The embodiments of the present disclosure will be described in detail hereinafter. Examples of the embodiments are shown in the accompanying drawings. The same or similar reference numerals throughout the drawings denote the same or similar elements or elements having the same or similar functions. The embodiments described below with reference to the accompanying drawings arc exemplary and are only intended to explain the present disclosure, but should not be construed as limiting the present disclosure.

In the description of the present disclosure, it shall be understood that the orientation or position relation related to the orientation description, such as the orientation or position relation indicated by the term upper, lower, front, rear, left, right, etc., is based on the orientation or position relation shown in the drawings, which is only used for convenience of description of the present disclosure and simplification of description instead of indicating or implying that the indicated device or element must have a specific orientation, and be constructed and operated in a specific orientation, and thus shall not be understood as a limitation to the present disclosure.

In the description of the present disclosure, the meaning of several refers to be one or more, and the meaning of multiple refers to be two or more. The meanings of greater than, less than, more than, etc., are understood as not including the following number, while the meanings of above, below, within, etc., are understood as including the following number. If there is a description to the first and second, it is only for the purpose of distinguishing between technical features, and shall not be understood as indicating or implying relative importance, implicitly indicating the number of the indicated technical features or implicitly indicating the order of the indicated technical features.

In the description of the present disclosure, unless otherwise explicitly defined, words such as setting, installing and connecting should be understood in a broad sense, and those of ordinary skills in the art can reasonably determine the specific meanings of the above words in the present disclosure in combination with the specific contents of the technical solutions.

In the description of the present disclosure, the descriptions with reference to “one embodiment”, “some embodiments”. “illustrative embodiments”. “examples”. “specific examples” or “some examples” mean that the specific features, structures, materials or characteristics described in connection with this embodiment or example are included in at least one embodiment or example of the present disclosure. In the description, the schematic representation of the above terms does not necessarily mean the same embodiment or example. Moreover, the specific features, structures, materials or characteristics described may be combined in any one or more embodiments or examples in a suitable manner.

A first embodiment of the present disclosure provides a wireless charger, which can realize automatic erection of a charging stand and reduce user operation. Referring to FIG. 1 to FIG. 3, the wireless charger according to the embodiment of the present disclosure comprises a base 100, a charging stand 200, a driving assembly 300 and a controller. The wireless charger can be placed or fixed on an external component through the base 100, the charging stand 200 is configured for supporting an electronic device and wirelessly charging the electronic device through an internal charging apparatus, and the controller can control the driving assembly 300 to drive the charging stand 200 to rotate relative to the base 100 to drive the electronic device to stand upright.

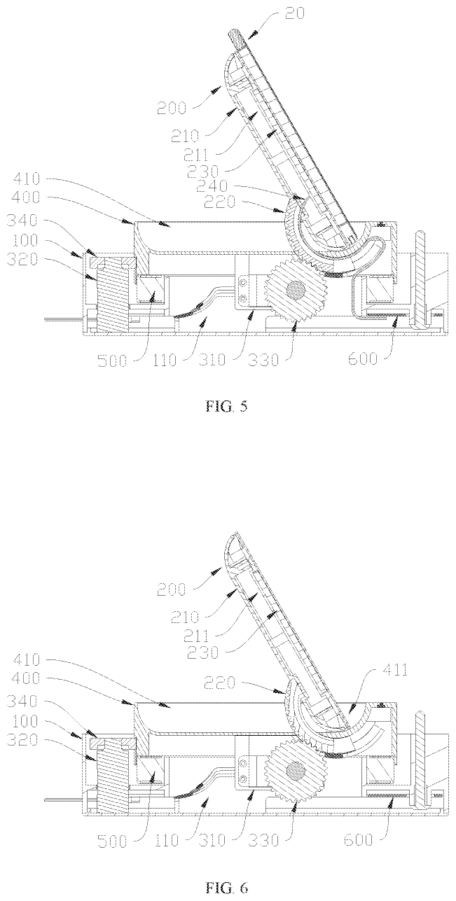

It should be noted that the upright or upright posture mentioned in the present disclosure is not strictly limited to the charging stand 200 or the electronic device being arranged in the vertical direction, but the charging stand 200 or the electronic device may also be inclined relative to the horizontal direction, and a rotating range of the charging stand 200 around the horizontal axis is 0 degree to 60 degrees. As shown in FIG. 5 and FIG. 6, for example, when the charging stand 200 rotates to the illustrated posture, it is convenient for the user to view a screen of the electronic device. When referring to the description of orientation in the present disclosure, it is explained when the wireless charger is in a normal use state. The electronic device referred to in the present disclosure comprises, but is not limited to, mobile phones, tablet computers and other devices.

The charging stand 200 is rotatably connected with the base 100, wherein the charging stand 200 may be directly rotatably connected with the base 100, or the charging stand 200 may be rotatably connected with an intermediate component first, and then connected with the base 100 through the intermediate component, which will be explained in different subsequent embodiments. In this embodiment, the charging stand 200 is directly connected with the base 100, and can rotate around a horizontal axis relative to the base 100. Specifically, the charging stand 200 and the base 100 may be rotatably connected by a rotating shaft, and may also be rotatably connected by an arc-shaped rotating block and a sliding rail. For the rotating shaft connection, the horizontal axis rotated by the charging stand 200 is a shaft axis of the rotating shaft. For the connection of the arc-shaped rotating block and the sliding rail, the horizontal axis rotated by the charging stand 200 passes through circle centers of the sliding block and the sliding rail.

Referring to FIG. 4 to FIG. 6, the charging stand 200 comprises a charging housing 210, a charging coil 230 and a wire 240. The charging housing 210 may be a circular housing as shown in the figure, and one side of the charging housing facing away from the base 100 is provided with a panel for placing the electronic device. An interior of the charging housing 210 is provided with an inner cavity 211, and the charging coil 230 is assembled in the inner cavity 211. In the illustrated embodiment, the charging coil 230 is mounted close to the panel to improve charging efficiency, and the wire 240 is electrically connected with the charging coil 230. When the wireless charger is provided with a switch, after the wireless charger is connected with an external power supply and the switch is turned on (that is, the wireless charger is in a state of waiting for charging), the electronic device may be placed on the charging stand 200 to start charging. When the wireless charger is not provided with a switch, after the wireless charger is connected with the external power supply (that is, the wireless charger is in a state of waiting for charging), the electronic device may be placed on the charging stand 200 to start charging.

The driving assembly 300 comprises a first power element 310. The first power element 310 comprises a first driving end which is rotatable. For example, the first power element 310 is a motor, and the first driving end is a driving shaft of the motor. The first driving end of the first power element 310 is connected with the charging stand 200 directly or through a transmission structure, thereby driving the charging stand 200 to rotate around the horizontal axis.

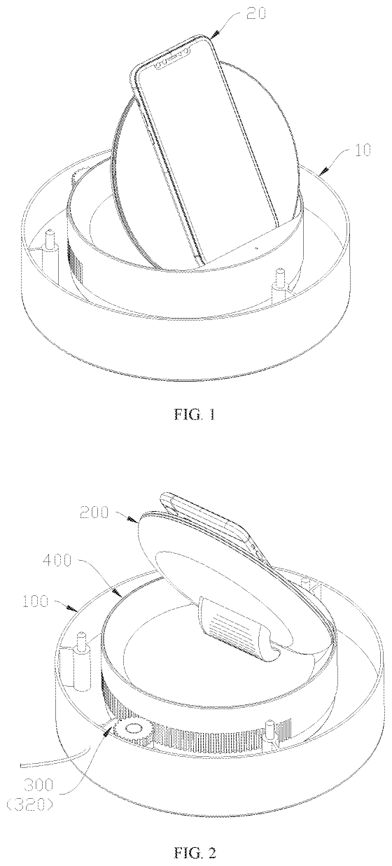

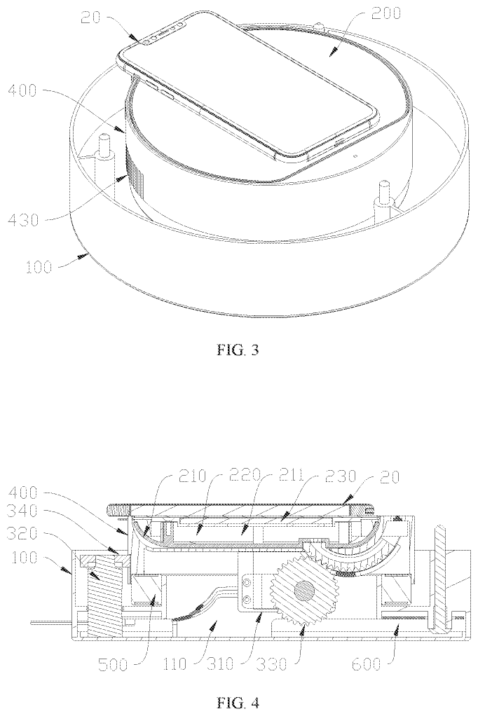

The controller is electrically connected with the first power element 310. In the illustrated embodiment, the controller is a circuit board 600 mounted on the base 100. In response to the placement of the electronic device 20 on the charging stand 200, the controller controls the first power element 310 to drive the charging stand 200 to rotate from an initial posture (for example, an initial posture shown in FIG. 3 and FIG. 4) to an upright posture (for example, an inclined posture shown in FIG. 1 and FIG. 2). In this process, the user only needs to place the electronic device on the charging stand 200, without manually driving the charging stand 200 to stand upright, or controlling the motor to rotate through a physical key or a virtual key and then driving the charging stand 200 to stand upright through the motor, so the operation is more convenient.

When the wireless charger is in a to-be-charged state, the electronic device may be placed on the charging stand 200 for charging. In some embodiments, the controller is further electrically connected with the charging coil 230, and the controller controls the first power element 310 based on a charging signal of the charging coil 230. Specifically, the charging signal of the charging coil 230 may be switching to a charging state. After the charging coil 230 switches from an uncharged state to the charging state, the controller controls the first power element 310 to drive the charging stand 200 to rotate from the initial posture to the upright posture, thereby driving the electronic device placed on the charging stand 200 to rotate from the initial posture to the upright posture. That is, the charging coil 230 of this embodiment not only can be used for wireless charging, and but also can cooperate with the controller to control the start of the first power element 310, without adding other control elements, which is helpful to simplify the structure and reduce the cost.

In some alternative embodiments, the wireless charger comprises a sensor (not shown), and the controller is further electrically connected with the sensor. The controller controls the first power element 310 based on a trigger signal of the sensor. Specifically, the sensor is connected to the charging stand 200, and can be triggered by the electronic device 20 placed on the charging stand 200. The trigger signal of the sensor may be switching to a trigger state. When the sensor switches from a non-trigger state to a trigger state, the controller controls the first power element 310 to drive the charging stand 200 to rotate from the initial posture to the upright posture, thereby driving the electronic device placed on the charging stand 200 to rotate from the initial posture to the upright posture.

In some embodiments, in response to the separation of the electronic device 20 from the charging stand 200, the controller controls the first power element 310 to drive the charging stand 200 to rotate from the upright posture to the initial posture, thus realizing the automatic reset of the charging stand 200 to further simplify the user operation.

Specifically, the controller is further electrically connected with the charging coil 230. After the charging coil 230 is switched from the charging state to the uncharged state, the controller controls the first power element 310 to drive the charging stand 200 to rotate from the upright posture to the initial posture. In addition, the wireless charger may further comprise a sensor (not shown), the sensor is connected to the charging stand 200 and can be triggered by the electronic device 20 placed on the charging stand 200. The controller is electrically connected with the sensor, and when the sensor is switched from the trigger state to the non-trigger state, the controller controls the first power element 310 to drive the charging stand 200 to rotate from the upright posture to the initial posture.

A second embodiment of the present disclosure further provides a wireless charger which is additionally provided with a rotating seat on the basis of the aforementioned first embodiment, so that the charging stand can rotate around the vertical axis in addition to being rotatable around the horizontal axis. This embodiment will focus on the differences from the first embodiment.

Referring to FIG. 1 to FIG. 3, the wireless charger according to the embodiment of the present disclosure comprises a base 100, a charging stand 200, a driving assembly 300, a rotating seat 400 and a controller. The wireless charger can be placed or fixed on an external component through the base 100, the charging stand 200 is configured for supporting an electronic device and wirelessly charging the electronic device through an internal charging apparatus, and the controller can control the driving assembly 300 to drive the charging stand 200 and the rotating seat 400 to rotate.

In this embodiment, the charging stand 200 is connected with the base 100 through the rotating seat 400. Specifically, the rotating seat 400 is rotatably connected with the base 100, and the rotating seat 400 can rotate around the vertical axis relative to the base 100. The charging stand 200 is rotatably connected with the rotating seat 400, and the charging stand 200 can rotate around the horizontal axis relative to the rotating seat 400, so that the charging stand 200 can rotate around the horizontal axis relative to the base 100 and rotate around the vertical axis relative to the base 100.

In this embodiment, the driving assembly 300 further comprises a second power element 320. The second power element 320 comprises a second driving end which is rotatable. For example, the second power element 320 is a motor, and the second driving end is a driving shaft of the motor. The second driving end of the second power element 320 is connected with the rotating seat 400 directly or through a transmission structure, thereby driving the rotating seat 400 to rotate around the vertical axis.

The controller is electrically connected with the first power element 310 and the second power element 320 respectively. In response to the placement of the electronic device 20 on the charging stand 200, the controller controls the first power element 310 to drive the charging stand 200 to rotate from the initial position to the upright position, and controls the second power element 320 to drive the rotating seat 400 to rotate from the initial position to the upright position, thus driving the electronic device to rotate from the initial posture to the upright posture, and driving the electronic device to rotate from the initial position to the set position, such that a screen of the electronic device faces the user. In this process, the user only needs to place the electronic device on the charging stand 200, without manually driving the charging stand 200 to stand upright, or controlling the motor to rotate through a physical key or a virtual key and then driving the charging stand 200 to stand upright through the motor, so that the operation is more convenient. In addition, when the wireless charger 10 is placed or fixed on a desk, and the placement position or fixed position of the wireless charger 10 is located at one side of a seat of the user, the screen of the electronic device can be made to face the user by rotating the rotating seat 400 around the vertical axis. It should be noted that the seat of the user is usually fixed. However, when the wireless charger 10 is placed or fixed on the desk, the placement position or fixed position of the wireless charger 10 and the initial position of the charging stand 200 are all fixed positions, so the above-mentioned set position may be calculated by the seat of the user, the placement position or fixed position of the wireless charger 10 and the initial position of the charging stand 200, and the rotation of the rotating seat 400 between the two positions can be realized by setting sensors at the corresponding initial position and set position.

In some alternative embodiments, in response to the placement of the electronic device 20 on the charging stand 200, the controller controls the first power element 310 to drive the charging stand 200 to rotate from the initial position to the upright position, and controls the second power element 320 to drive the rotating seat 400 to rotate from the initial position by a set angle, so that the screen of the electronic device faces the user. It should be noted that, according to the seat of the user, the placement position or fixed position of the wireless charger 10 and the initial position of the charging stand 200, a required rotation angle by which the charging stand 200 rotates a position where the screen of the electronic device faces the user can be calculated. In this embodiment, the controller can control a parking position of the charging stand 200 by controlling the rotation angle of the charging stand 200, so it is possible to not set the sensors at the initial position and the set position, or only set the sensor at the initial position.

It should be noted that the rotation angle of the rotating seat 400 is 0 degree to 120 degrees, and the rotating seat 400 can rotate from the initial state to the left or the right, that is, the rotation range of one side is 0 degree to 60 degrees, depending on different mounting positions of the wireless charger 10.

Based on the aforementioned second embodiment and the corresponding alternative embodiments, in some embodiments, the controller is further electrically connected with the charging coil 230, and the controller controls the first power element 310 based on a charging signal of the charging coil 230. Specifically, the charging signal of the charging coil 230 may be switching to a charging state. After the charging coil 230 switches from an uncharged state to a charging state, the controller controls the first power element 310 to drive the charging stand 200 to rotate from the initial posture to the upright posture, and controls the second power element 320 to drive the rotating seat 400 to rotate from the initial position to the set position, thereby driving the electronic device placed on the charging stand 200 to rotate from the initial posture to the upright posture, and driving the electronic device to rotate from the initial position to the set position. That is, the charging coil 230 of this embodiment not only can be used for wireless charging, and but also can cooperate with the controller to control the start of the first power element 310, without adding other control elements, which is helpful to simplify the structure and reduce the cost.

In some alternative embodiments, the wireless charger comprises a sensor (not shown), and the controller is further electrically connected with the sensor. The controller controls the first power element 310 based on a trigger signal of the sensor. Specifically, the sensor is connected to the charging stand 200, and can be triggered by the electronic device 20 placed on the charging stand 200. The trigger signal of the sensor may be switching to a trigger state. When the sensor switches from a non-trigger state to a trigger state, the controller controls the first power element 310 to drive the charging stand 200 to rotate from the initial posture to the upright posture, and controls the second power element 320 to drive the rotating seat 400 to rotate from the initial position to the set position, thereby driving the electronic device placed on the charging stand 200 to rotate from the initial posture to the upright posture, and driving the electronic device to rotate from the initial position to the set position.

Based on the aforementioned second embodiment and corresponding alternative embodiments, in some embodiments, in response to the separation of the electronic device 20 from the charging stand 200, the controller controls the first power element 310 to drive the charging stand 200 to rotate from the upright posture to the initial posture, and controls the second power element 320 to drive the rotating seat 400 to rotate from the set position to the initial position, thus realizing the automatic reset of the charging stand 200 to further simplify the user operation.

Specifically, the controller is further electrically connected with the charging coil 230. After the charging coil 230 is switched from the charging state to the uncharged state, the controller controls the first power element 310 to drive the charging stand 200 to rotate from the upright posture to the initial posture, and controls the second power element 320 to drive the rotating seat 400 to rotate from the set position to the initial position. In addition, the wireless charger may further comprise a sensor (not shown), the sensor is connected to the charging stand 200 and can be triggered by the electronic device 20 placed on the charging stand 200. The controller is electrically connected with the sensor, and when the sensor is switched from the trigger state to the non-trigger state, the controller controls the first power element 310 to drive the charging stand 200 to rotate from the upright posture to the initial posture, and controls the second power element 320 to drive the rotating seat 400 to rotate from the set position to the initial position.

It should be noted that the sensor of the above embodiments may be a sensor triggered by physical pressing, such as a travel switch, or a sensor triggered by an optical signal, such as a photoelectric switch.

It should also be noted that when the wireless charger 10 is provided with the rotating seat 400, the charging stand 200 may rotate from the initial posture to the upright posture first, and then the rotating seat 400 may rotate from the initial position to the set position, or after the rotating seat 400 rotates from the initial position to the set position, the charging stand 200 may rotate from the initial posture to the upright posture, or the charging stand 200 may rotate synchronously with the rotating seat 400.

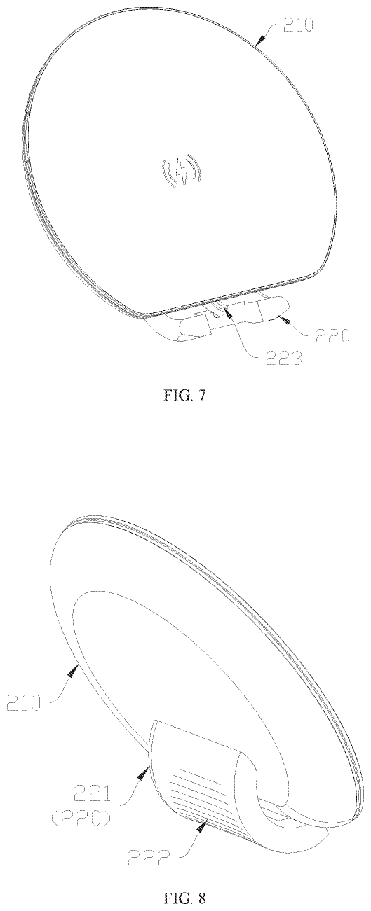

The above embodiments describe the solution of the rotation control of the charging stand 200 in the second embodiment of the present disclosure. Next, some specific structures of the charging stand 200 and the rotating seat 400 will be described with reference to the drawings. Based on the aforementioned second embodiment and the corresponding alternative embodiments, in some embodiments, the charging stand 200 further comprises a connecting portion 220 connected to the charging housing 210. The connecting portion 220 is provided with an arc surface 221 and a plurality of first driving teeth 222 distributed along a circumferential direction of the arc surface 221. The arc surface 221 is a circular arc surface, and a horizontal rotating axis of the charging stand 200 passes through a circle center of the arc surface. Specifically, referring to FIG. 7 and FIG. 8, the whole connecting portion 220 is an arc section, and one side of the connecting portion facing away from the charging housing 210 is the aforementioned arc surface 221. An upper end of the connecting portion 220 is connected to a back plate of the charging stand 210 facing the base 100, and a lower end of the connecting portion is bent and extended to a lower side of the charging stand 210, wherein the connecting portion 220 may be integrated with the charging stand 210 as one piece or connected with the charging housing 210 as an independent component through a structure such as a threaded fastener.

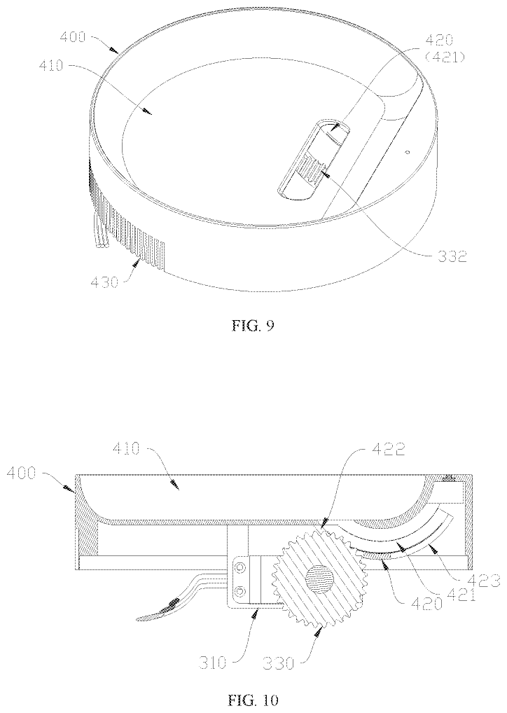

Referring to FIG. 9 and FIG. 10 and in conjunction with FIG. 4 to FIG. 6, the driving assembly 300 of this embodiment further comprises a first gear 330 connected to the first driving end of the first power element 310, and the first gear 330 is engaged with the first driving teeth 222, thereby realizing power transmission.

When the first power element 310 drives the charging stand 200 to rotate through the first gear 330 and the first driving teeth 222, in some embodiments, referring to FIG. 4 to FIG. 6, a bottom portion of the rotating seat 400 and the base 100 define a first mounting cavity 110, so that the first mounting cavity 110 is hidden at a lower side of the rotating seat 400 after the rotating seat 400 is connected to the base 100.

In this embodiment, referring to FIG. 9 and FIG. 10, the rotating seat 400 is provided with a guide portion 420 located in the first mounting cavity 110, and the guide portion 420 defines a guide cavity 421. A shape of the guide cavity 421 is adapted to a shape of the connecting portion 220, which may for example be circular arc-shaped cavity. The connecting portion 220 is arranged in the guide cavity 421, and the connecting portion 220 can slide along a circular arc-shaped track in an extending direction of the guide cavity 421, thus realizing the rotation of the rotating seat 400 around the horizontal axis.

A wall of the guide cavity 421 is provided with a first notch 422, and the first power element 310 and the first gear 330 may be mounted in the first mounting cavity 110 in a hidden way. Some teeth of the first gear 330 extend into the guide cavity 421 through the first notch 422, so as to keep being engaged with the first driving teeth 222 of the connecting portion 220 in the guide cavity 421.

It should be noted that, instead of using the connecting portion 220 and the guide portion 420, the charging stand 200 may use a rotating shaft and a shaft hole where the rotating shaft is mounted, so as to realize the rotary connection between the charging stand 200 and the rotating seat 400. For example, rotating shafts are arranged at both sides of the charging stand 200, and rotating shaft holes are arranged correspondingly at the rotating seat 400.

In some embodiments, referring to FIG. 7 and FIG. 8, the connecting portion 220 is further provided with a trunking 223. The trunking 223 extends along a length direction of the connecting portion 220, an upper end of the trunking is communicated with the inner cavity 211 of the charging housing 210, and a lower end of the trunking extends into the guide cavity 421. Referring to FIG. 5, the wire 240 of the charging stand 200 extends out of the charging housing 210, extends along the trunking 223, and enters the guide cavity 421. The wall of the guide cavity 421 is provided with a second notch 423, and the wire 240 can enter the first mounting cavity 110 through the second notch 423, so as to be electrically connected with the circuit board arranged inside the wireless charger 10.

As shown in FIG. 5, the wire 240 includes at least one bent section. For example, after the wire 240 leaves the guide cavity 421 through the second notch 423, the wire may bend downward to form the bent section. The bent section can buffer the wire 240 during the rotation of the charging stand 200, and prevent a joint of an end portion of the wire 240 from being pulled to cause failure of the charger. Specifically, when the charging stand 200 rotates from the initial posture to the upright posture or from the initial position to the set position, the bent section will be gradually straightened, and when the charging stand 200 rotates from the upright posture to the initial posture or from the set position to the initial position, the bent section will gradually return to bending.

In some embodiments, referring to FIG. 5. FIG. 6. FIG. 9 and FIG. 10, a top portion of the rotating seat 400 defines a recess 410, and a shape of the recess 410 is matched with an outer contour of the charging stand 200. For example, when the charging stand 200 is a circular charging stand as shown in the figure, the recess 410 is a circular recess. When the charging stand 200 is in the initial posture, the charging stand 200 is at least partially located in the recess 410, so that a protruding height of the charging stand 200 in the initial posture can be reduced, on one hand, a thickness of the wireless charger 10 can be reduced, and on the other hand, the charging stand 200 can be protected. Taking the illustration as an example, when the charging stand 200 is in the initial posture, the charging stand 200 is completely located in the recess 410, and an upper surface of the charging stand 200 is flushed with or lower than an upper surface of the rotating seat 400.

In order to adapt to the rotation of the charging stand 200 relative to the rotating seat 400, a side wall of the recess 410 is provided as an are surface, and a cross-sectional area of the recess 410 gradually increases along a direction from a bottom portion of the recess to an opening of the recess. Correspondingly, an outer side wall of the charging stand 200 is also provided as an arc surface, so that the charging stand 200 can smoothly rotate relative to the rotating seat 400.

In some embodiments, referring to FIG. 6, a top portion of the rotating seat 400 defines a recess 410. When the charging stand 200 is in the upright posture, the charging stand 200 and a wall of the recess 410 define an accommodating space 411. Specifically, a lower end of the charging stand 200 and a circular arc-shaped wall of the recess 410 define the accommodating space 411. In this way, when the charging stand 200 rotates from the initial posture to the upright posture, a bottom end of the electronic device 20 will slide into the accommodating space 411 and abut against the wall of the recess 410, and combined with the support of the charging stand 200 on a back of the electronic device 20, the electronic device 20 can be stably maintained in the upright posture.

In some embodiments, referring to FIG. 1 to FIG. 3 and in conjunction with FIG. 11, the rotating seat 400 is provided with a plurality of second driving teeth 430 distributed along the circumferential direction, and the driving assembly 300 further comprises a second gear 340 connected to a second driving end of the second power element 320. The second gear 340 is engaged with the second driving teeth 430. When working, the second power element 320 can drive the rotating seat 400 to rotate through the second gear 340 and the second driving teeth 430, wherein the second power element 320 is a motor and the second driving end is a driving shaft of the motor. It should be noted that, in this embodiment, the second driving teeth 430 on the rotating seat 400 is engaged with the second gear 340 instead of a traditional driven gear, so that a quantity of components can be reduced, compact mounting can be realized, and a volume of the wireless charger 10 can be reduced.

Specifically, in the illustrated embodiment, the rotating seat 400 has a circular cylindrical structure as a whole, and the second driving teeth 430 are arranged on an outer side wall of the rotating seat 400. According to a rotation angle of the rotating seat 400 around the vertical axis, the second driving teeth 430 may be arranged around an outer circumference of the rotating seat 400 for one circle or one section.

It should be noted that, in some other embodiments, the positions of the second driving teeth 430 may also be changed according to the position change of the second power element 320, for example, arranged on an inner side wall of the rotating seat 400.

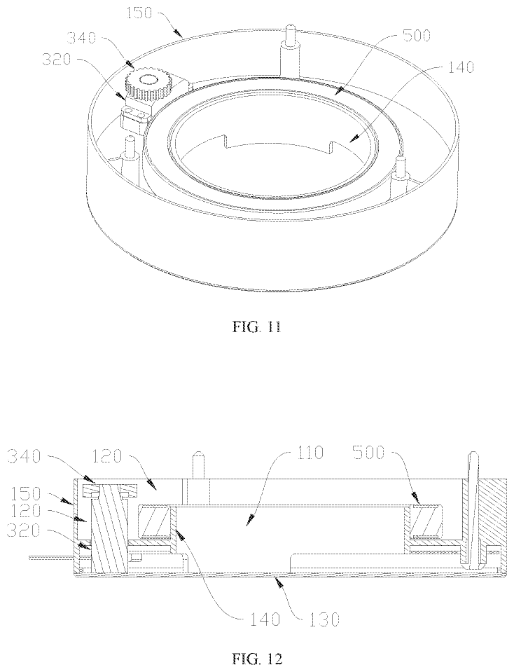

In some embodiments, the base 100 is internally provided with different cavities to mount different components respectively. Referring to FIG. 12, the base 100 comprises a bottom plate 130, and an inner side plate 140 and an outer side plate 150 both connected to the bottom plate 130, wherein the outer side plate 150 is located outside the inner side plate 140, for example connected to an outer edge of the base plate 130, and both the inner side plate 140 and the outer side plate 150 are annular side plates, specifically circular annular side plates. The rotating seat 400, the inner side plate 140 and the bottom plate 130 define the first mounting cavity 110, and the first power element 310 is arranged in the first mounting cavity 110. Combined with the guide portion 420 arranged in the first mounting cavity 110, the first power element 310 may be hidden in the first mounting cavity 110 to drive the charging stand 200. It should be noted that the first power element is connected to the rotating seat 400 and can rotate synchronously with the rotating seat 400.

The inner side plate 140, the outer side plate 150 and the bottom plate 130 define a second mounting cavity 120, and the second power element 320 is arranged in the second mounting cavity 120. By arranging two independent mounting cavities, the two power elements can be placed separately. In addition, when the wireless charger 10 is connected to a desk, the base 100 is arranged on a lower side of the desk, and a top end of the outer side plate 150 abuts against a lower surface of the desk, thus realizing the hidden mounting of the second power element 320. Taking the illustration as an example, the base 100 further comprises a mounting column arranged between the inner side plate 140 and the outer side plate 150 and extending upward, and the mounting column is configured for connecting the base 100 with the desk plate.

In some embodiments, when the inner side plate 140, the outer side plate 150 and the bottom plate 130 define the second mounting cavity 120, referring to FIG. 4 to FIG. 6, and in conjunction with FIG. 11 and FIG. 12, the wireless charger 10 further comprises an annular bearing 500. The annular bearing 500 is arranged in the second mounting cavity 120, and the rotating seat 400 is rotatably connected with the base 100 through the annular bearing 500, which can realize smooth rotation of the rotating seat 400 and compact assembly. The annular bearing 500 may be connected to the bottom plate 130, an outer side wall of the inner side plate 140, an inner side wall of the inner side plate 140 or an inner side wall of the outer side plate 150, and the rotating seat 400 is placed on an upper side of the annular bearing 500.

It should be noted that, in the first embodiment of the present disclosure, the connection solution between the charging stand 200 and the base 100 may be understood by referring to the connection solution between the charging stand 200 and the rotating seat 400 in the second embodiment. In order to facilitate understanding, the rotating seat 400 and the base 100 may formed as an integrated structure. In this case, the rotating seat 400 becomes a part of the base 100. For example, in some embodiments, the charging stand 200 further comprises a connecting portion 220 connected to the charging housing 210, and the connecting portion 220 is provided with an arc surface 221 and a plurality of first driving teeth 222 distributed along a circumferential direction of the arc surface 221. The arc surface 221 is a circular are surface, and a horizontal rotating axis of the charging stand 200 passes through a circle center of the arc surface. The whole connecting portion 220 is provided as an arc section, and one side of the connecting portion facing away from the charging housing 210 is the aforementioned arc surface 221. An upper end of the connecting portion 220 is connected to a back plate of the charging stand 210 facing the base 100, and a lower end of the connecting portion is bent and extended to a lower side of the charging stand 210, wherein the connecting portion 220 may be integrated with the charging stand 210 as one piece or connected with the charging housing 210 as an independent component through a structure such as a threaded fastener.

The driving assembly 300 further comprises a first gear 330 connected to the first driving end of the first power element 310, and the first gear 330 is engaged with the first driving teeth 222, thereby realizing power transmission.

For another example, in some other embodiments, when the first power element 310 drives the charging stand 200 to rotate through the first gear 330 and the first driving teeth 222, a bottom portion of the base 100 defines a first mounting cavity 110, and the base 100 is provided with a guide portion 420 located in the first mounting cavity 110, and the guide portion 420 defines a guide cavity 421. A shape of the guide cavity 421 is adapted to a shape of the connecting portion 220, for example, the guide cavity 421 may be a circular arc-shaped cavity. The connecting portion 220 is arranged in the guide cavity 421, and the connecting portion 220 can slide along a circular arc-shaped track in an extending direction of the guide cavity 421, thus realizing the rotation of the rotating seat 400 around the horizontal axis.

A wall of the guide cavity 421 is provided with a first notch 422, and the first power element 310 and the first gear 330 may be mounted in the first mounting cavity 110 in a hidden way. Some teeth of the first gear 330 extend into the guide cavity 421 through the first notch 422, so as to keep being engaged with the first driving teeth 222 of the connecting portion 220 in the guide cavity 421.

For another example, in some embodiments, the connecting portion 220 is further provided with a trunking 223. The trunking 223 extends along a length direction of the connecting portion 220, an upper end of the trunking is communicated with the inner cavity 211 of the charging housing 210, and a lower end of the trunking extends into the guide cavity 421. The wire 240 of the charging stand 200 extends out of the charging housing 210, extends along the trunking 223, and enters the guide cavity 421. The wall of the guide cavity 421 is provided with a second notch 423, and the wire 240 can enter the first mounting cavity 110 through the second notch 423, so as to be electrically connected with the circuit board arranged inside the wireless charger 10.

For another example, in some embodiments, a top portion of the base 100 defines a recess 410, and a shape of the recess 410 is matched with an outer contour of the charging stand 200. For example, when the charging stand 200 is a circular charging stand as shown in the figure, the recess 410 is a circular recess. When the charging stand 200 is in the initial posture, the charging stand 200 is at least partially located in the recess 410, so that a protruding height of the charging stand 200 in the initial posture can be reduced, on one hand, a thickness of the wireless charger 10 can be reduced, and on the other hand, the charging stand 200 can be protected. Taking the illustration as an example, when the charging stand 200 is in the initial posture, the charging stand 200 is completely located in the recess 410, and an upper surface of the charging stand 200 is flushed with or lower than an upper surface of the base 100.

In order to adapt to the rotation of the charging stand 200 relative to the base 100, a side wall of the recess 410 is provided as an arc surface, and a cross-sectional area of the recess 410 gradually increases along a direction from a bottom portion of the recess to an opening of the recess. Correspondingly, an outer side wall of the charging stand 200 is also provided as an arc surface, so that the charging stand 200 can smoothly rotate relative to the base 100.

For another example, in some embodiments, a top portion of the base 100 defines a recess 410. When the charging stand 200 is in the upright posture, the charging stand 200 and a wall of the recess 410 define an accommodating space 411. Specifically, a lower end of the charging stand 200 and a circular arc-shaped wall of the recess 410 define the accommodating space 411. In this way, when the charging stand 200 rotates from the initial gesture to the upright gesture, a bottom end of the electronic device 20 will slide into the accommodating space 411 and abut against the wall of the recess 410, and combined with the support of the charging stand 200 on a back of the electronic device 20, the electronic device 20 can be stably maintained in the upright posture.

It should be noted that when the base 100 is provided with the aforementioned recess 410 and the first mounting cavity 110 at the same time, the recess 410 is located above the first mounting cavity 110 and separated from the first mounting cavity 110 by a structure such as a partition plate, and the guide portion 420 is connected to a lower side of a partition portion.

For another example, in some embodiments, the driving assembly 300 comprises a first power element 310. The first power element 310 comprises a first driving end which is rotatable. The first power element 310 may be a motor, and the first driving end is a driving shaft of the motor. The first driving end of the first power element 310 is connected with the charging stand 200 directly or through a transmission structure, thereby driving the charging stand 200 to rotate around the horizontal axis. When the first power element 310 drives the charging stand 200 to rotate through the first gear 330 and the first driving teeth 222, the first power element 310 is located in the first mounting cavity 110, so as to realize the hidden mounting of the first power element 310 after the charging stand 200 is connected to the base 100.

It should be noted that, referring to the foregoing embodiments, it may be understood that the charging stand 200 of the present disclosure can be directly connected to the base 100 or indirectly connected to the base 100 through an intermediate component, and the intermediate component may be the aforementioned rotating seat 400.

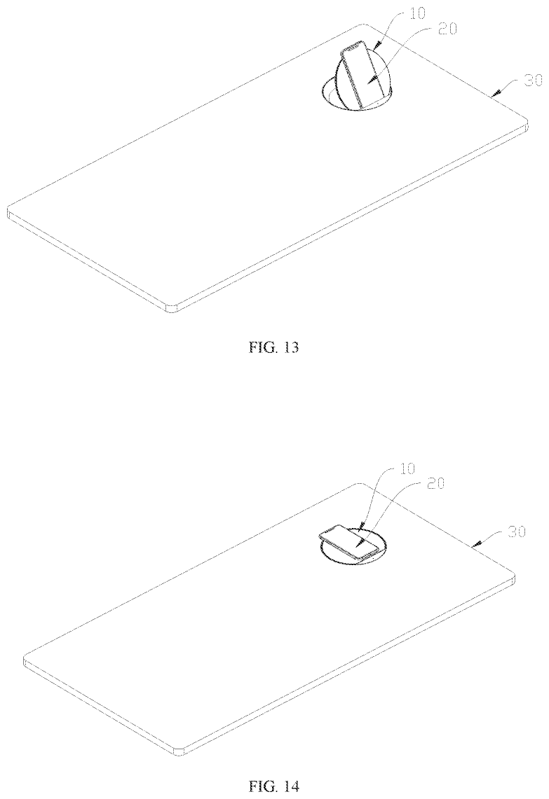

A third embodiment of the present disclosure further provides a desk. Referring to FIG. 13 to FIG. 15, the desk comprises a desk plate 30, a support structure which is not shown, and the wireless charger according to the previous embodiments. The desk plate 30 is provided with a horizontally arranged upper surface for carrying, and the desk plate 30 may be any shape comprising a rectangle, which is not limited by the present disclosure. The support structure is used to support the desk plate 30, which may be an independent structure or a structure integrated with the desk plate 30. The support structure may be a rod-shaped desk leg or a solid or hollow base.

The wireless charger is connected to the desk plate 30 through the base 100. In some embodiments, the base 100 is directly installed on the upper surface of the desk plate 30, that is, the whole wireless charger 10 is located on an upper side of the desk plate 30. In some other embodiments, the desk plate 30 is provided with a mounting hole which extends at least across the upper surface of the desk plate 30, and the wireless charger 10 is at least partially located in the mounting hole.

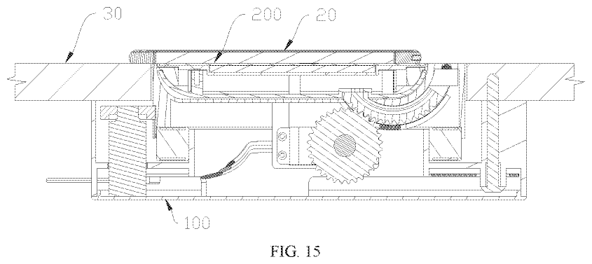

Referring to FIG. 15, when the desk plate 30 is provided with the aforementioned mounting hole, the wireless charger 10 is arranged in the mounting hole, and when the charging stand 200 is in the initial posture, the upper surface of the charging stand 200 is not higher than the upper surface of the desk plate 30, so as to avoid the formation of a protruding structure on the desk plate 30 to affect use. Taking the illustration as an example, when the charging stand 200 is in the initial posture, the upper surface of the charging stand 200 is flush with the upper surface of the desk plate 30, which prevents the desk plate 30 from forming a concave area in appearance, and at the same time, is convenient to place the electronic device on the charging stand 200.

It should be noted that the wireless charger 10 is embedded in the mounting hole when the mounting hole only extends upward across the upper surface of the desk plate 30. When the mounting extends upward across the upper surface of the desk plate 30 and extends downward across the lower surface of the desk plate 30, the wireless charger 10 is arranged to extend across the mounting hole. For example, as shown in FIG. 15, the base 100 of the wireless charger 10 is arranged on the lower side of the desk plate 30 and is fixedly connected with the desk plate 30, while the rotating seat 400 and the charging stand 200 extend across the mounting hole.

It should be noted that, in some embodiments, the wireless charger 10 is the aforementioned wireless charger 10 which is provided with the rotating seat 400. Referring to FIG. 13 and FIG. 14, the desk plate 30 of this embodiment is a rectangular desk plate which has a first side line and a second side line which are adjacent and perpendicular to each other. The wireless charger 10 of this embodiment can be connected with the desk plate 30 in the aforementioned manner.

Typically, there is a certain deviation between a mounting position of the wireless charger 10 and a seat of the user. For example, the wireless charger 10 is mounted at a corner of the desk plate 30, and the seat of the user is located at a center of a long side of the desk plate 30. In order to facilitate the user to view the electronic device while charging, it is necessary to ensure that a screen of the electronic device faces the user. The rotating seat 400 of this embodiment can rotate between the initial position and the set position. When the rotating seat 400 of this embodiment is in the initial position, the user can place the electronic device on the charging stand 200 in a way that conforms to the habit of holding by a hand. Taking a mobile phone as an example, the mobile phone has a rectangular structure, and when held by a hand, a long side of the mobile phone will be oriented roughly perpendicular to a human body. Therefore, when the user places the electronic device from one side of the desk plate 30, the electronic device is also kept in a posture roughly parallel to the first side line or the second side line. However, after the electronic device in this posture stands upright, it is difficult for the screen to face the user. If the electronic device is placed on the charging stand 200 in advance, it will require the user to perform additional rotation, which is not in conformity with the holding habit, and it is difficult to ensure that an angle of each placement can meet viewing requirements. Based on this, in this embodiment, by rotating the rotating seat 400 from the initial position to the set position (as mentioned above, this position is calculated based on the wireless charger 10 and the seat of the user), the screen of the electronic device can face the user when it is upright, which is convenient for the user to view. That is, this embodiment not only allows the user to place the electronic device in a comfortable posture, but also ensures that the electronic device faces the user when charging, which is convenient for the user to view when charging.

The embodiments of the present disclosure are described in detail with reference to the drawings above, but the present disclosure is not limited to the above embodiments, and various changes may also be made within the knowledge scope of those of ordinary skills in the art without departing from the purpose of the present disclosure. In addition, in case of no conflict, the embodiments in the present disclosure and the features in the embodiments may be combined with each other.

What is claimed is:

1. A wireless charger for wirelessly charging an electronic device, comprising:
a base;
a charging stand connected to the base and rotatable around a horizontal axis relative to the base, wherein the charging stand is configured for placing the electronic device and wirelessly charging the electronic device;
a driving assembly; and
a controller electrically connected with the driving assembly and configured for controlling the driving assembly to drive the charging stand to rotate from an initial posture to an upright posture in response to placing the electronic device on the charging stand, wherein when the charging stand is in the upright posture, an included angle between the electronic device placed on the charging stand and a horizontal plane is greater than 0 degree and less than or equal to 90 degrees.

2. The wireless charger according to claim 1, wherein the wireless charger further comprises a rotating seat, the rotating seat is connected to the base and is rotatable around a vertical axis relative to the base, and the charging stand is connected to the rotating seat and is rotatable around the horizontal axis relative to the rotating seat;
wherein the controller is configured for controlling the driving assembly to drive the charging stand to rotate from the initial posture to the upright posture and controlling the driving assembly to drive the rotating seat to rotate from an initial position to a set position or to rotate by a set angle in response to placing the electronic device on the charging stand.

3. The wireless charger according to claim 2, wherein a top portion of the rotating seat defines a recess, and the wireless charger comprises at least one of the following solutions:
when the charging stand is in the initial posture, the charging stand is at least partially located in the recess; and
when the charging stand is in the upright posture, the charging stand and a wall of the recess define an accommodating space for accommodating a bottom end of the electronic device.

4. The wireless charger according to claim 2, wherein the charging stand comprises a charging housing and a connecting portion connected to the charging housing, the connecting portion is provided with an arc surface and a plurality of first driving teeth distributed along a circumferential direction of the arc surface, the driving assembly comprises a first power element and a first gear connected to a driving end of the first power element, and the first gear is engaged with the first driving teeth.

5. The wireless charger according to claim 4, wherein a bottom portion of the rotating seat and the base define a first mounting cavity, the rotating seat is provided with a guide portion located in the first mounting cavity, the guide portion defines a guide cavity, the connecting portion is slidably arranged in the guide cavity, and the wireless charger comprises at least one of the following solutions:
a wall of the guide cavity is provided with a first notch for the first gear to be engaged with the first driving teeth; and
the connecting portion further defines a trunking communicated with an inner cavity of the charging housing, the charging stand further comprises a charging coil arranged in the inner cavity and a wire electrically connected with the charging coil, the wire is arranged in the trunking, and the wall of the guide cavity is provided with a second notch for the wire to pass through.

6. The wireless charger according to claim 2, wherein the rotating seat is provided with a plurality of second driving teeth distributed along a circumferential direction, the driving assembly comprises a second power element and a second gear connected to a driving end of the second power element, and the second gear is engaged with the second driving teeth.

7. The wireless charger according to claim 2, wherein the base comprises a bottom plate, and an inner side plate and an outer side plate which are connected to the bottom plate, the outer side plate is located outside the inner side plate, the inner side plate and the bottom plate define a first mounting cavity, the inner side plate, the outer side plate and the bottom plate define a second mounting cavity, and the wireless charger comprises at least one of the following solutions:
the driving assembly comprises a first power element for driving the charging stand to rotate, and the first power element is arranged in the first mounting cavity;
the driving assembly comprises a second power element for driving the rotating seat to rotate, and the second power element is arranged in the second mounting cavity; and
the wireless charger further comprises an annular bearing, the annular bearing is arranged in the second mounting cavity, and the rotating seat is rotatably connected with the base through the annular bearing.

8. The wireless charger according to claim 2, wherein the charging stand comprises a charging housing and a charging coil, and the controller is configured for controlling the driving assembly to drive the charging stand to rotate from the initial posture to the upright posture and controlling the driving assembly to drive the rotating seat to rotate from the initial position to the set position in response to placing the electronic device on the charging stand to charge the electronic device through the charging coil;
or, the charging stand comprises a sensor, the sensor is capable of being triggered by the electronic device placed on the charging stand, and the controller is configured for controlling the driving assembly to drive the charging stand to rotate from the initial posture to the upright posture and controlling the driving assembly to drive the rotating seat to rotate from the initial position to the set position in response to triggering of the sensor.

9. The wireless charger according to claim 1, wherein a top portion of the base defines a recess, and the wireless charger comprises at least one of the following solutions:
when the charging stand is in the initial posture, the charging stand is at least partially located in the recess; and
when the charging stand is in the upright posture, the charging stand and a wall of the recess define an accommodating space for accommodating a bottom end of the electronic device.

10. The wireless charger according to claim 1, wherein the charging stand comprises a charging housing and a connecting portion connected to the charging housing, the connecting portion is provided with an arc surface and a plurality of first driving teeth distributed along a circumferential direction of the arc surface, the driving assembly comprises a first power element and a first gear connected to a driving end of the first power element, and the first gear is engaged with the first driving teeth.

11. The wireless charger according to claim 10, wherein the base defines a first mounting cavity, the base is provided with a guide portion located in the first mounting cavity, the guide portion defines a guide cavity, the connecting portion is slidably arranged in the guide cavity, and the wireless charger comprises at least one of the following solutions:
a wall of the guide cavity is provided with a first notch for the first gear to be engaged with the first driving teeth;
the connecting portion further defines a trunking communicated with an inner cavity of the charging housing, the charging stand further comprises a charging coil arranged in the inner cavity and a wire electrically connected with the charging coil, the wire is arranged in the trunking, and the wall of the guide cavity is provided with a second notch for the wire to pass through; and
the first power element is arranged in the first mounting cavity.

12. The wireless charger according to claim 1, wherein the charging stand comprises a charging housing and a charging coil, and the controller is configured for controlling the driving assembly to drive the charging stand to rotate from the initial posture to the upright posture in response to placing the electronic device on the charging stand to charge the electronic device through the charging coil;
or, the charging stand comprises a sensor, the sensor is capable of being triggered by the electronic device placed on the charging stand, and the controller is configured for controlling the driving assembly to drive the charging stand to rotate from the initial posture to the upright posture in response to triggering of the sensor.

13. A desk, comprising:
a desk plate; and
a wireless charger, wherein the wireless charger is connected to the desk plate through the base, and comprises:
a base;
a charging stand connected to the base and rotatable around a horizontal axis relative to the base, wherein the charging stand is configured for placing the electronic device and wirelessly charging the electronic device;
a driving assembly; and
a controller electrically connected with the driving assembly and configured for controlling the driving assembly to drive the charging stand to rotate from an initial posture to an upright posture in response to placing the electronic device on the charging stand, wherein when the charging stand is in the upright posture, an included angle between the electronic device placed on the charging stand and a horizontal plane is greater than 0 degree and less than or equal to 90 degrees;
wherein the desk plate is provided with a mounting hole for mounting the wireless charger, the mounting hole extends at least across an upper surface of the desk plate, and when the charging stand is in the initial posture, an upper surface of the charging stand is not higher than the upper surface of the desk plate.

14. The desk according to claim 13, wherein the wireless charger further comprises a rotating seat, the rotating seat is connected to the base and is rotatable around a vertical axis relative to the base, and the charging stand is connected to the rotating seat and is rotatable around the horizontal axis relative to the rotating seat;
wherein the controller is configured for controlling the driving assembly to drive the charging stand to rotate from the initial posture to the upright posture and controlling the driving assembly to drive the rotating seat to rotate from an initial position to a set position or to rotate by a set angle in response to placing the electronic device on the charging stand,

15. The desk according to claim 14, wherein a top portion of the rotating seat defines a recess, and the wireless charger comprises at least one of the following solutions:
when the charging stand is in the initial posture, the charging stand is at least partially located in the recess; and
when the charging stand is in the upright posture, the charging stand and a wall of the recess define an accommodating space for accommodating a bottom end of the electronic device.

16. The desk according to claim 14, wherein the charging stand comprises a charging housing and a connecting portion connected to the charging housing, the connecting portion is provided with an arc surface and a plurality of first driving teeth distributed along a circumferential direction of the arc surface, the driving assembly comprises a first power element and a first gear connected to a driving end of the first power element, and the first gear is engaged with the first driving teeth;
wherein a bottom portion of the rotating seat and the base define a first mounting cavity, the rotating seat is provided with a guide portion located in the first mounting cavity, the guide portion defines a guide cavity, the connecting portion is slidably arranged in the guide cavity, and the wireless charger comprises at least one of the following solutions:
a wall of the guide cavity is provided with a first notch for the first gear to be engaged with the first driving teeth; and
the connecting portion further defines a trunking communicated with an inner cavity of the charging housing, the charging stand further comprises a charging coil arranged in the inner cavity and a wire electrically connected with the charging coil, the wire is arranged in the trunking, and the wall of the guide cavity is provided with a second notch for the wire to pass through.

17. The desk according to claim 14, wherein the rotating seat is provided with a plurality of second driving teeth distributed along a circumferential direction, the driving assembly comprises a second power element and a second gear connected to a driving end of the second power element, and the second gear is engaged with the second driving teeth.

18. The desk according to claim 14, wherein the base comprises a bottom plate, and an inner side plate and an outer side plate which are connected to the bottom plate, the outer side plate is located outside the inner side plate, the inner side plate and the bottom plate define a first mounting cavity, the inner side plate, the outer side plate and the bottom plate define a second mounting cavity, and the wireless charger comprises at least one of the following solutions:
the driving assembly comprises a first power element for driving the charging stand to rotate, and the first power element is arranged in the first mounting cavity;
the driving assembly comprises a second power element for driving the rotating seat to rotate, and the second power element is arranged in the second mounting cavity; and
the wireless charger further comprises an annular bearing, the annular bearing is arranged in the second mounting cavity, and the rotating seat is rotatably connected with the base through the annular bearing.

19. The desk according to claim 13, wherein a top portion of the base defines a recess, and the wireless charger comprises at least one of the following solutions:
when the charging stand is in the initial posture, the charging stand is at least partially located in the recess; and
when the charging stand is in the upright posture, the charging stand and a wall of the recess define an accommodating space for accommodating a bottom end of the electronic device.

20. The desk according to claim 13, wherein the charging stand comprises a charging housing and a connecting portion connected to the charging housing, the connecting portion is provided with an arc surface and a plurality of first driving teeth distributed along a circumferential direction of the arc surface, the driving assembly comprises a first power element and a first gear connected to a driving end of the first power element, and the first gear is engaged with the first driving teeth;
wherein the base defines a first mounting cavity, the base is provided with a guide portion located in the first mounting cavity, the guide portion defines a guide cavity, the connecting portion is slidably arranged in the guide cavity, and the wireless charger comprises at least one of the following solutions:
a wall of the guide cavity is provided with a first notch for the first gear to be engaged with the first driving teeth;
the connecting portion further defines a trunking communicated with an inner cavity of the charging housing, the charging stand further comprises a charging coil arranged in the inner cavity and a wire electrically connected with the charging coil, the wire is arranged in the trunking, and the wall of the guide cavity is provided with a second notch for the wire to pass through; and
the first power element is arranged in the first mounting cavity.
